(19) United States
(12) Patent Application Publication
(10) Pub. No.: US 2025/0130844 A1
(43) Pub. Date: Apr. 24, 2025

(54) Security Framework for Virtual Machines

(71) Applicant: Advanced Micro Devices, Inc., Santa Clara, CA (US)

(72) Inventors: Reshma Lal, Vancouver, WA (US); David A. Kaplan, Austin, TX (US); Jelena Ilic, Austin, TX (US)

(73) Assignee: Advanced Micro Devices, Inc., Santa Clara, CA (US)

(21) Appl. No.: 18/926,095

(22) Filed: Oct. 24, 2024

Related U.S. Application Data
(60) Provisional application No. 63/592,916, filed on Oct. 24, 2023.

(51) Int. Cl. G06F 9/455

(52) U.S. Cl. CPC G06F 9/45558; G06F 2009/45587

(57) ABSTRACT

A security framework for virtual machines is described. In one or more implementations, a hardware platform comprises physical computer hardware, the physical computer hardware including one or more processing units and one or more memories. The system also includes a virtual machine monitor configured to virtualize the physical computer hardware of the hardware platform to instantiate a plurality of framework-secure virtual machines. Further, the system includes a root framework-secure virtual machine instantiated by the virtual machine monitor. In accordance with the described techniques, the root framework-secure virtual machine is configured to control access to the hardware platform by the framework-secure virtual machines instantiated by the virtual machine monitor.

### PRIORITY

This application claims priority to U.S. Provisional Patent Application No. 63/592,916, filed Oct. 24, 2023, the disclosure of which is hereby incorporated by reference in its entirety.

### BACKGROUND

Security is essential for virtual machines, such as virtual machines being run using web service providers. Implementing appropriate security measures not only helps protect sensitive data but also ensures compliance with various information disclosure regulations. Security measures are crucial in maintaining network security, preventing unauthorized access, and mitigating risks from potential threats. By safeguarding against vulnerabilities, a reliability and integrity of virtual environments can be ensured.

### BRIEF DESCRIPTION OF THE DRAWINGS

FIG. 1 is a block diagram of a non-limiting example system having a hardware platform that is operable to enable a security framework for virtual machines instantiated by a computing system hardware platform using techniques described herein.

FIG. 2 is a block diagram of a non-limiting example system showing the hardware platform of FIG. 1 in greater detail as launching a root framework-secure virtual machine in accordance with the described techniques.

FIG. 3 is a block diagram of a non-limiting example system showing the hardware platform of FIG. 1 in greater detail as launching a virtual machine without special privileges and configuring the virtual machine as a root framework-secure virtual machine having special privileges.

FIG. 4 is a block diagram of a non-limiting example system showing the hardware platform of FIG. 1 in greater detail as launching different instances of a root framework-secure virtual machine in accordance with the described techniques.

FIG. 5 is a block diagram of a non-limiting example procedure describing performance of launching a root framework-secure virtual machine in accordance with the described techniques.

FIG. 6 is a block diagram of a non-limiting example procedure describing a lifecycle of a root framework-secure virtual machine in accordance with the described techniques.

### DETAILED DESCRIPTION

In computing system architectures where different virtual machines access data stored in system memory, private memory pages for a guest virtual machine are protected via access control by a designated computing system compute unit, such as a security processor. Security processor access control prevents unauthorized virtual machines from reading from or writing into the private memory of the guest virtual machine. Such access control, however, presents challenges, as the designated compute unit that performs access control is resource-constrained, resulting in performance and scalability limits for the computing system. For example, a compute unit (e.g., a security processor) tasked with access control has reduced compute resources (e.g., relative to a central processing unit), slower access to memory, reduced processing power, and so forth, which creates a bottleneck that prevents computing systems from instantiating additional virtual machines without significantly hindering system latency. Accordingly, conventional access control techniques limit a number of virtual machines that can be supported by a given computing system.

To address these conventional shortcomings, a security framework for virtual machines is described. In implementations, a root-trusted guest, such as a root framework-secure virtual machine is loaded by a computing system hardware platform and authenticated as a trustworthy entity. For instance, a computing system virtual machine monitor (e.g., a hypervisor) causes the root-trusted guest to generate a guest attestation report that includes information such as an authoring entity (e.g., a developer) associated with the root-trusted guest, a security version number of the root-trusted guest, and a cryptographic measurement of the root-trusted guest's memory pages. For instance, the virtual machine monitor generates a hash that represents a cryptographic measurement of private memory pages loaded from the root-trusted guest. The security version number and the authoring entity associated with the root-trusted guest are then used to obtain a security certificate provided by the authoring entity of the root-trusted guest.

The hash representing the cryptographic measurement of the root-trusted guest's private memory pages are compared against the security certificate. In response to the cryptographic hash measurement matching the security certificate, such a match means that the root-trusted guest is secure and trustworthy (e.g., that binary code of the root-trusted guest is exactly as released by the authoring entity). Alternatively, if the cryptographic hash measurement does not match the security certificate, such a discrepancy is evidence of interference (e.g., malicious tampering with binary code of the root-trusted guest) and indicates that the root-trusted guest cannot be trusted (e.g., that the virtual machine is regarded by the computing system as a “guest” instead of a “root-trusted guest”).

In response to authenticating a root-trusted guest loaded onto a computing system, the root-trusted guest is assigned a unique identifier (e.g., an address-space identifier (ASID)). Other unique identifiers include a cryptographic token, virtual machine identifier, and so forth. The unique identifier assigned to the root-trusted guest is unique in that it is assignable to only a single root-trusted guest and is immutable (e.g., persists for as long as the root-trusted guest is loaded onto the computing system). Upon loading the root-trusted guest onto the computing system, a designated security compute unit (e.g., a security processor) logs the unique identifier assigned to the root-trusted guest by writing the unique identifier into an isolated region of computing system memory. The isolated memory region in which the unique identifier is logged is accessible by host components of the computing system (e.g., central processing units of the computing system) and is inaccessible to computing system guests (e.g., virtual machines loaded onto the computing system) other than the root-trusted guest having the logged unique identifier.

While a guest is running (e.g., executing one or more operations as part of performing a computational task) and issues a request to access computing system resources (e.g., requests to access data stored in computing system memory), a security processor compares the guest's unique identifier with the unique identifier stored in the isolated memory region. In response to the requesting guest having a unique identifier that matches the unique identifier stored in the isolated memory region, the security processor permits the request to proceed. For instance, in an example scenario where the isolated memory region stores a single unique identifier that represents a root-trusted guest, only requests from the root-trusted guest are granted while requests from other guests are denied.

To alleviate the performance shortcomings facing conventional systems, the described techniques enable a root-trusted guest to execute commands on behalf of different computing system guests using data included in memory pages that are private to the different computing system guests (e.g., grant requests from other guests loaded onto the computing system). To do so, the computing system grants special privileges to the root-trusted guest that permit the root-trusted guest to execute memory operations using a guest's private memory page (e.g., read from and write to a target guest page for a target guest). In implementations, the target guest page represents a data structure maintained in memory of the computing system that is associated with a unique identifier for the target guest (e.g., a unique identifier that is different from the unique identifier representing the root-trusted guest). In this manner, the techniques described herein enable hardware platforms to realize technical advantages not afforded by conventional system architectures (e.g., decreased power consumption, decreased latency, additional bandwidth, and so forth).

In some aspects, the techniques described herein relate to a system including a hardware platform including physical computer hardware, the physical computer hardware including one or more processing units and one or more memories, a virtual machine monitor configured to virtualize the physical computer hardware of the hardware platform to instantiate a plurality of framework-secure virtual machines, and a root framework-secure virtual machine instantiated by the virtual machine monitor, the root framework-secure virtual machine configured to control access to the hardware platform by the plurality of framework-secure virtual machines instantiated by the virtual machine monitor.

In some aspects, the techniques described herein relate to a system, wherein the root framework-secure virtual machine is instantiated with permissions that are not granted to the plurality of framework-secure virtual machines.

In some aspects, the techniques described herein relate to a system, wherein the root framework-secure virtual machine is configured to implement a security framework for the plurality of framework-secure virtual machines.

In some aspects, the techniques described herein relate to a system, wherein the virtual machine monitor is configured to instantiate the root framework-secure virtual machine by transmitting an initialization message that causes the root framework-secure virtual machine to generate an attestation report that is useable by the hardware platform to authenticate the root framework-secure virtual machine.

In some aspects, the techniques described herein relate to a system, wherein the attestation report includes information describing at least one of an authoring entity associated with the root framework-secure virtual machine, a security version of the root framework-secure virtual machine, or a memory page to be loaded by the hardware platform for the root framework-secure virtual machine.

In some aspects, the techniques described herein relate to a system, wherein the virtual machine monitor is configured to authenticate the root framework-secure virtual machine by generating a cryptographic measurement of the memory page to be loaded by the hardware platform for the root framework-secure virtual machine.

In some aspects, the techniques described herein relate to a system, wherein the virtual machine monitor is configured to authenticate the root framework-secure virtual machine by obtaining a security certificate from the authoring entity associated with the root framework-secure virtual machine and compare the cryptographic measurement against the security certificate.

In some aspects, the techniques described herein relate to a system, wherein the one or more memories include an isolated memory region that is accessible to the root framework-secure virtual machine and inaccessible to the plurality of framework-secure virtual machines.

In some aspects, the techniques described herein relate to a system, wherein the virtual machine monitor is configured to instantiate the root framework-secure virtual machine by writing a unique identifier for the root framework-secure virtual machine to the isolated memory region.

In some aspects, the techniques described herein relate to a system, wherein the root framework-secure virtual machine is configured to clear the unique identifier from the isolated memory region prior to shutting down.

In some aspects, the techniques described herein relate to a system, wherein the virtual machine monitor is configured to clear the unique identifier from the isolated memory region in response to detecting that the unique identifier persists in the isolated memory region after shutdown of the root framework-secure virtual machine.

In some aspects, the techniques described herein relate to a system, wherein the virtual machine monitor is configured to instantiate an additional root framework-secure virtual machine in response to detecting that the unique identifier persists in the isolated memory region after shutdown of the root framework-secure virtual machine.

In some aspects, the techniques described herein relate to a system, wherein the virtual machine monitor is configured to instantiate the root framework-secure virtual machine by providing data describing a status and configuration information for the hardware platform to the root framework-secure virtual machine.

In some aspects, the techniques described herein relate to a method including launching, by a computing device, a virtual machine, authenticating, by the computing device, the virtual machine by generating a cryptographic measure of at least one memory page loaded by the virtual machine, configuring, by the computing device, the virtual machine as a root framework-secure virtual machine that is configured to control access to the computing device by at least one other virtual machine, and executing, using hardware resources of the computing device, at least one command issued by the root framework-secure virtual machine on behalf of the at least one other virtual machine.

In some aspects, the techniques described herein relate to a method, wherein authenticating the virtual machine includes obtaining a security certificate from an authoring entity associated with the virtual machine and comparing the cryptographic measure of the at least one memory page against the security certificate.

In some aspects, the techniques described herein relate to a method, wherein configuring the virtual machine as the root framework-secure virtual machine includes writing a unique identifier for the root framework-secure virtual machine to an isolated region in memory of the computing device that is accessible to the root framework-secure virtual machine and inaccessible to the at least one other virtual machine.

In some aspects, the techniques described herein relate to a method, further including clearing the unique identifier for the root framework-secure virtual machine from the isolated region in the memory of the computing device in response to detecting an unintended shutdown of the root framework-secure virtual machine.

In some aspects, the techniques described herein relate to a method, further including transmitting a shutdown command to the root framework-secure virtual machine that causes the root framework-secure virtual machine to clear the unique identifier for the root framework-secure virtual machine from the isolated region in the memory of the computing device prior to shutting down.

In some aspects, the techniques described herein relate to a method, wherein launching the virtual machine includes providing data describing a status and configuration information for the computing device to the virtual machine.

In some aspects, the techniques described herein relate to a method including receiving, by a virtual machine, an initialization message from a virtual machine monitor of a hardware platform, sending, by the virtual machine and to the virtual machine monitor, an attestation report in response to receiving the initialization message, the attestation report including information describing at least one of an authoring entity of the virtual machine, a security version of the virtual machine, or a memory page to be loaded into memory of the hardware platform for the virtual machine, receiving, by the virtual machine and from the virtual machine monitor, data that permits the virtual machine to control access, to the hardware platform, by at least one other virtual machine instantiated by the virtual machine monitor, and executing, by the virtual machine and using resources of the hardware platform, at least one command on behalf of the at least one other virtual machine.

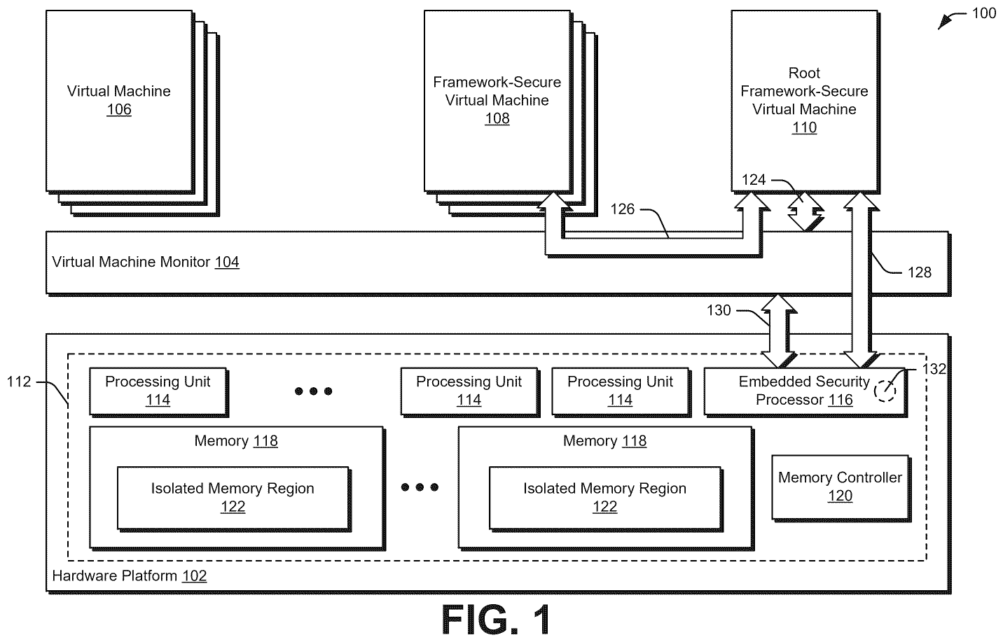

FIG. 1 is a block diagram of a non-limiting example system 100 having a hardware platform that is operable to enable a security framework for virtual machines instantiated by a computing system hardware platform using techniques described herein. In this example, the system 100 includes hardware platform 102 as well as virtual machine monitor 104, one or more virtual machines 106, one or more framework-secure virtual machines 108, and root framework-secure virtual machine 110, which are run on the hardware platform 102.

In this example, the hardware platform 102 is depicted including data fabric 112, one or more processing units 114, embedded security processor 116, one or more memories 118, and memory controller 120. Thus, in accordance with the described techniques, one or more of the virtual machine monitor 104, a virtual machine 106, a framework-secure virtual machine 108, and/or a root framework-secure virtual machine 110 operate by utilizing one or more of the underlying resources of the hardware platform 102 (e.g., one or more of the data fabric 112, a processing unit 114, the embedded security processor 116, a memory 118, or the memory controller 120). In one or more implementations, one or more isolated regions of the memory 118 (e.g., isolated memory region 122) are involved when implementing the virtual machine security framework techniques described herein.

In variations, the hardware platform 102 includes more, fewer, and/or different hardware components without departing from the spirit or scope of the described techniques (e.g., cache, secondary storage, semiconductor intellectual property (IP) core, and so forth). Additionally, throughout the following description various components of the system 100 are referred to in the singular and/or in the plural, such as the hardware platform 102, the above-mentioned components of the hardware platform 102 (e.g., one or more processing units 114), the virtual machine monitor 104, the virtual machine 106, the framework-secure virtual machine 108, and/or the root framework-secure virtual machine 110. In implementations, however, the number of such components used to implement the described techniques varies without departing from the spirit or scope of the described techniques. While use of one, single embedded security processor 116 and one, single root framework-secure virtual machine 110 is discussed throughout, in at least one variation, multiple security processors and/or multiple root framework-secure virtual machines are used to implement the described techniques, such as in connection with multiple hardware platforms (e.g., used at a data center and/or by a web service provider).

In the illustrated example, the above-described components (e.g., the data fabric 112, the one or more processing units 114, the one or more memories 118, the embedded security processor 116, the memory controller 120, etc.) are depicted as being included in the hardware platform 102. Examples of the hardware platform 102 include, but are not limited to, one or more of a system-on-chip (SoC) or a system-on-package (SoP).

In accordance with the described techniques, one or more of the processing unit 114, the embedded security processor 116, the memory 118, or the memory controller 120 are coupled to one another via one or more of a wired or wireless connection (e.g., implemented using the data fabric 112). Example wired connections include, but are not limited to, memory channels, buses (e.g., a data bus, a system or address bus), interconnects, through silicon vias, traces, and planes. Other example connections include optical connections, fiber optic connections, and/or connections or links based on quantum entanglement.

Examples of devices or apparatuses in which the system 100 is implemented include, but are not limited to, one or more server computers, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The processing unit 114 is an electronic circuit that performs various operations on and/or using data in the memory 118. Examples of the processing unit 114 include, but are not limited to, a central processing unit (CPU), a graphics processing unit (GPU), a field programmable gate array (FPGA), an accelerator, an accelerated processing unit (APU), and a digital signal processor (DSP), to name a few. In at least one variation, the processing units 114 of the hardware platform 102 are all of a same type (e.g., all CPUs, all a same model of CPUs, all GPUs, etc.). Alternatively, the hardware platform 102 includes at least two different types of processing units 114 (e.g., at least one CPU and at least one GPU, two different types of CPUs, combinations thereof, and so forth).

The memory 118 is a device or system that is used to store information, such as for immediate use in a device by the processing unit 114 or by an in-memory processor (not depicted in FIG. 1), which is referred to as a processing-in-memory component or PIM component. In one or more implementations, the memory 118 corresponds to semiconductor memory where data is stored within memory cells on one or more integrated circuits. In at least one example, the memory 118 corresponds to or includes volatile memory, examples of which include random-access memory (RAM), dynamic random-access memory (DRAM), synchronous dynamic random-access memory (SDRAM), static random-access memory (SRAM), and memristors.

The memory 118 is packaged or configured in any of a variety of different manners. Examples of such packaging or configuring include a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to, mounted to, etc.) the hardware platform 102 (or other printed circuit board), combinations thereof, and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 118 is configured as or includes a SO-DIMM or an RDIMM according to one of the above-mentioned standards (e.g., DDR, DDR2, DDR3, DDR4, and DDR5).

Alternatively or in addition, the memory 118 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). The memory 118 is configurable in a variety of ways capable of supporting thermal management using an adjustable thermal management algorithm and/or receiving power managed using such an adjustable algorithm.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the memory 118 is configurable in a variety of ways without departing from the spirit or scope of the described techniques.

In at least one variation, the memories 118 of the hardware platform 102 are all of a same type (e.g., all DRAMs, all a same model of DRAMs, all MRAM, etc.). Alternatively, the hardware platform 102 includes at least two different types of processing units 114 (e.g., at least one DRAM and a cache system, two different types of DRAM, combinations thereof, and so forth).

The memory controller 120 is a hardware component or subsystem that manages the flow of data to and from the memory 118. By way of example, the memory controller 120 includes logic to read and write to the memory 118 and interface with the processing unit 114. In one or more implementations, the memory controller 120 also includes logic to read and write to various levels of a cache hierarchy (not shown). For instance, the memory controller 120 receives instructions from the processing unit 114, which involve accessing the memory 118, and the memory controller 120 provides data from the memory 118 to the processing unit 114 (e.g., for processing by the processing unit 114). In one or more implementations, the memory controller 120 is communicatively and/or topologically located between the processing unit 114 and the memory 118, and the memory controller 120 interfaces with both the processing unit 114 and the memory 118.

The virtual machine monitor 104 is a software and/or hardware component that virtualizes the physical computer hardware of the hardware platform 102. The virtual machine monitor 104 allocates and manages physical resources of the hardware platform 102 to run one or more virtualized instances of a computer (i.e., virtual machines) on the hardware platform 102. The underlying computing device(s) (e.g., the hardware platform 102) utilized by a virtual machine monitor to instantiate virtual machines is often referred to as a “host.” In contrast, an individual virtual machine instantiated using the hardware platform 102 is often referred to as a “guest.” In the context of the system 100, the virtual machine monitor 104 allocates and manages physical resources of the hardware platform 102, such as the processing unit 114, the embedded security processor 116, the memory 118, and/or the memory controller 120 to instantiate and/or manage one or more virtual machines. A virtual machine monitor is also referred to as a “hypervisor,” examples of which are a Type 1 Hypervisor (e.g., a bare-metal hypervisor) and a Type-2 Hypervisor (e.g., a hosted hypervisor).

In one or more implementations, a “virtual machine” is the virtualization or emulation of a computer system to provide the functionality of the physical computer system. In variations, virtual systems are the virtualization or emulation of computer systems having a range of functionality, for instance, from providing a substitute of a real machine (e.g., being instantiated with the resources used to execute an entire operating system) to executing a computer program in a platform independent manner. In implementations, the capabilities of virtual machines and/or of different virtual machines differs without departing from the spirit or scope of the described techniques.

In accordance with the described techniques, each of the one or more virtual machines 106, the one or more framework-secure virtual machines 108, and the root framework-secure virtual machine 110 is a “virtual machine.”

However, the one or more virtual machines 106, the one or more framework-secure virtual machines 108, and the root framework-secure virtual machine 110 represent instantiations having different characteristics (e.g., deployed in accordance with a security framework) and/or having different functionalities (e.g., managing deployment of the security framework). In one or more implementations, the one or more virtual machines 106 are instantiated by the virtual machine monitor 104 using the underlying resources of the hardware platform 102, but security of the one or more virtual machines 106 is not managed according to a particular security framework.

One example of the security framework is Secure Encrypted Virtualization-Secure Nested Paging (SEV-SNP). The SEV-SNP framework builds upon SEV and SEV-ES (Encrypted State) functionality while adding new hardware-based security protections. For instance, SEV-SNP adds strong memory integrity protection to prevent malicious hypervisor-based attacks like data replay, memory re-mapping, and more in order to create an isolated execution environment. SEV-SNP also introduces several additional optional security enhancements designed to support additional virtual machine use models stronger protection around interrupt behavior, and offers increases protection against side channel attacks, to name a few enhancements. In implementations, the particular security framework differs from SEV-SNP without departing from the described techniques.

In contrast to the one or more virtual machines 106, which are not instantiated or otherwise managed according to the particular security framework (e.g., SEV-SNP), the one or more framework-secure virtual machines 108 and the root framework-secure virtual machine 110 are implemented in accordance with the particular security technique. Further, the root framework-secure virtual machine 110 differs from the one or more framework-secure virtual machines 108 insofar as the root framework-secure virtual machine 110 is configured with elevated permissions (e.g., to access one or more portions of the hardware platform 102) and is operable to control various accesses of one or more portions of the hardware platform 102 by the one or more framework-secure virtual machines 108.

In conventional approaches, some security frameworks are implemented using the embedded security processor 116 and/or without the use of a root framework-secure virtual machine 110. By way of example, conventional SEV-SNP approaches perform guest management and trusted input output (I/O)—management of virtual machines within the security framework such as the one or more framework-secure virtual machines 108—using the embedded security processor 116. In one or more variations, though, the embedded security processor 116 is a slower (e.g., significantly slower) processor than the processing unit 114, which in one or more variations is implemented according to a family of complex instruction set computer (CISC) instruction set architectures, such as x86. Compared to a processing unit 114 implemented according to such an instruction set architecture, for instance, the embedded security processor 116 has limited compute and memory resources.

The embedded security processor 116 also has higher latency when accessing system memory (e.g., the memory 118) relative to the processing unit 114, which decreases the throughput of the embedded security processor 116 when the embedded security processor 116 reads and writes into the system memory during management of the one or more framework-secure virtual machines 108 and during other functions. These differences contribute to higher latency in SEV-SNP security services provided by the embedded security processor 116. Moreover, performance (e.g., throughput) and scaling issues are exacerbated as the number of virtual machines deployed (e.g., by the virtual machine monitor 104) increases, such as with a number of core counts of newer platform hardware (e.g., processing units with more cores) and/or as new security features are added to keep up with evolving data center regulations.

In contrast to conventional approaches, the root framework-secure virtual machine 110 is instantiated and works in concert with the embedded security processor 116 and the virtual machine monitor 104 to implement the security framework (e.g., SEV-SNP). Because the root framework-secure virtual machine 110 is allowed to run management of the one or more framework-secure virtual machines 108 and/or trusted input/output (TIO) using the processing unit 114 (e.g., in x86), the described system 100 improves performance (e.g., increased throughput, reduced latency, etc.) of the particular security framework (e.g., SEV-SNP) relative to conventional systems. Moreover, the described system 100 also enables security features of the security framework to be easily scaled, such as to support various protocols including secure compute express link (CXL), graphics processing unit (GPU) support, and so on.

The illustrated example also depicts communication interfaces between various depicted components, including an interface 124, an interface 126, an interface 128, and an interface 130. In one or more implementations, the interface 124, the interface 126, the interface 128, and the interface 130 are at least, in part, activated and/or managed during runtime by the virtual machine monitor 104, which leverages various code of the virtual machine monitor 104 (e.g., hypervisor), and according to the particular security framework (e.g., SEV-SNP). In one or more implementations, the interface 126 and the interface 128 are secured according to the particular security framework (e.g., those interfaces are encrypted), such that the virtual machine monitor 104 cannot access (e.g., “see”) the data being communicated across those interfaces-even though the virtual machine monitor 104 facilitates communication of such. In contrast, the interface 124 and the interface 130 are not secured in the same manner, (e.g., interface 124 and interface 130 are not encrypted). In one or more implementations, the interface 124 and the interface 130 are cleartext interfaces.

In one or more implementations, the interface 124 is used for communication of commands of the root framework-secure virtual machine 110 that are available to the virtual machine monitor 104 for management of the one or more framework-secure virtual machines 108. In one or more implementations, the interface 126 is used for communication of messages from the one or more framework-secure virtual machines 108 to the root framework-secure virtual machine 110. In one or more implementations, the interface 128 is used for communication of messages from the root framework-secure virtual machine 110 to the firmware 132 of the embedded security processor 116. In one or more implementations, the interface 130 is used for communication of firmware 132 commands to initialize the security framework and for management (e.g., initialization, runtime management, and shutdown) of the root framework-secure virtual machine 110. The various messages communicated across those interfaces are discussed in more detail below.

The system 100 discussed above and below improves performance of a particular security framework (e.g., SEV-SNP) by moving management of the one or more framework-secure virtual machines 108, trusted I/O, and other security functions from firmware 132 of the embedded security processor 116 into hardware-protected software (e.g., the root framework-secure virtual machine 110) executing on an x86 processor, e.g., the processing unit 114. The described techniques include a set of hardware and firmware mechanisms, and system interfaces (e.g., the interfaces 124-130), to enable the root framework-secure virtual machine 110, a privileged SNP virtual machine, to perform secure virtual machine management. The improvement leverages existing SEV-SNP protections such as reverse mapping table, memory encryption and I/O protections, to protect root framework-secure virtual machine 110's execution and provides special privileges via the processing unit 114 (e.g., CPU) and firmware capabilities described herein.

In one or more implementations, the capabilities of the processing unit 114 and the firmware 132 of the embedded security processor 116 include establishing the run time identity of the root framework-secure virtual machine 110 and locking the identity, allowing the root framework-secure virtual machine 110 to leverage the identity of a framework-secure virtual machine 108 for reading/writing pages of the target framework-secure virtual machine, allowing the root framework-secure virtual machine 110 to read/write into locations of the memory 118 (e.g., the isolated memory region 122) that are not available to any x86 software where examples of those locations include RMP tables and fenced memory regions outside the system memory, performing an atomic update of RMP table entries without bit masking, perform translation lookaside buffer (TLB) flushing for one or more framework-secure virtual machines 108, securely load and update software of the root framework-secure virtual machine 110, and establishing an interface between the root framework-secure virtual machine 110 and the embedded security processor 116.

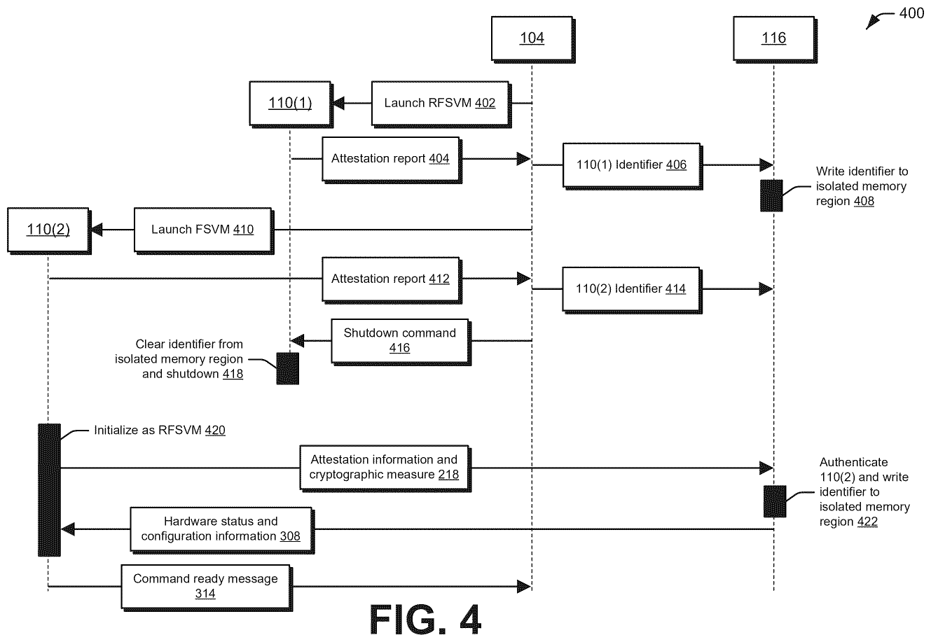

While root framework-secure virtual machine 110 is identified by its unique identifier (e.g., the root framework-secure virtual machine 110's ASID), similar to the one or more framework-secure virtual machines 108, the security-framework firmware 132 (e.g., implemented by the embedded security processor 116) promotes the root framework-secure virtual machine 110 (e.g., from a previous instantiation as being a framework-secure virtual machine 108, as described in further detail below with respect to FIG. 4) to have unique privileges by writing the unique identifier of the root framework-secure virtual machine 110 into a location of the memory 118 that is only accessible to the processing unit 114 (e.g., executing the code to implement the root framework-secure virtual machine 110) and the security-framework firmware 132. This is done only after the security-framework firmware 132 has verified the root framework-secure virtual machine 110's identity by reading an identity block of the root framework-secure virtual machine 110, which is initiated by the root framework-secure virtual machine 110 itself during initialization. Once the unique identifier of the root framework-secure virtual machine 110 is written in the fenced memory location (e.g., isolated memory region 122), only the root framework-secure virtual machine 110 or the embedded security processor 116 can clear its unique identifier at the time the root framework-secure virtual machine 110 is shutdown. The processing unit 114 (e.g., CPU) executing the code to implement the root framework-secure virtual machine 110 checks if the unique identifier of the root framework-secure virtual machine 110 matches the unique identifier of the currently running framework secure virtual machine and grants the currently running machine special privileges only if the unique identifier matches.

When the root framework-secure virtual machine 110 is set to read or write one or more private pages of a target framework-secure virtual machine 108, the processing unit 114 uses the unique identifier of the target framework-secure virtual machine 108 and also uses system physical address (SPA) of the page of the target framework-secure virtual machine 108. The root framework-secure virtual machine 110 provides the unique identifier of the target framework-secure virtual machine 108 to the processing unit 114 via a register, such as via a write to a model-specific register (e.g., a target unique identifier model-specific register (MSR)).

In one or more implementations, the root framework-secure virtual machine 110 tags one or more private memory pages of the target framework-secure virtual machine 108 using a special encoding in a guest page table of the root framework-secure virtual machine 110 (e.g., memory pages loaded by a framework-secure virtual machine 108 to memory 118). This special encoding informs the processing unit 114 which memory page represented by a page table entry corresponds to the target framework-secure virtual machine 108.

In accordance with the described techniques, existing flows for launching a framework-secure virtual machine 108 are modified to detect the root framework-secure virtual machine 110's identity during the launch process by verifying that the code of the root framework-secure virtual machine 110 is signed and has expected version numbers (e.g., including the security version number (SVN)). In accordance with the particular security framework, the identify of the root framework-secure virtual machine 110 is stored in the firmware 132 of the embedded security processor 116. When the root framework-secure virtual machine 110 is first run by the virtual machine monitor 104 using a utility and/or command (e.g., VMRUN), the root framework-secure virtual machine 110 calls an initialization function in the firmware 132 (e.g., of the embedded security processor 116) which establishes the root framework-secure virtual machine 110's identity for a processing unit 114's use by writing the identity into a location that is accessible to the processing unit 114 and the firmware 132 only. The root framework-secure virtual machine 110 clears memory of the processing unit 114 used to store the unique identifier (e.g., ASID) of the root framework-secure virtual machine 110 when the root framework-secure virtual machine 110 is terminated.

The interface 128 between the root framework-secure virtual machine 110 and the embedded security processor 116 allows the root framework-secure virtual machine 110 to provide the commands via the root framework-secure virtual machine 110's private pages and for the firmware 132 of the embedded security processor 116 to return a response by writing the response directly into a private page of the root framework-secure virtual machine 110 instead of using an existing message based protocol between the one or more framework-secure virtual machines 108 and firmware 132 of the security framework (e.g., on the embedded security processor 116).

In at least one implementation, the modifications to the architecture of system 100 leverages the security framework (e.g., SNP) architecture to host a trusted software-implemented module (e.g., executed code or binary at least one processing unit 114) as a privileged root virtual machine (e.g., root framework-secure virtual machine 110). Further, the root framework-secure virtual machine 110 is protected using hardware security enforcements such as reverse mapping table protection and memory encryption.

In one or more implementations, the root framework-secure virtual machine 110 is signed by an authority, is authenticated and loaded securely by the embedded security processor 116, has strong hardware enforced identity that can be checked by processing unit 114 and the firmware 132 before granting the root framework-secure virtual machine 110 special privileges, has special hardware privileges that allows the root framework-secure virtual machine 110 to perform guest management, trusted I/O and other functions, is in the trusted computing base (TCB) of all framework-secure virtual machines 108 and is included in attestation of framework-secure virtual machines 108.

In one or more implementations, the described system 100 redistributes responsibilities relative to conventional techniques leveraging the security framework to improve scalability and reduce latency, among other improvements. In one or more implementations, for example, the functions of the embedded security processor 116, after redistribution, include initialization and shutdown of the security framework; configuring cores, memory encryption engines, and the input/output (I/O) memory management unit (IOMMU); initializing reverse mapping tables (RMP) and micro-architectural structures; security framework trusted I/O (e.g., SEV-TIO initialization); trusted computing base (TCB) and attestation key management, management of the root framework-secure virtual machine 110, low level hardware functions for guest and trusted input/output (I/O), which is also referred to as “TIO” management, and programming framework secure virtual machine keys in UMC, integrity and data encryption key in RC, and flushing data fabric.

In one or more implementations, the functions of the root framework-secure virtual machine 110, after redistribution, include management of the one or more framework-secure virtual machines 108; launching, activating, and decommissioning the one or more framework-secure virtual machines 108; runtime management (e.g., page swap, move, unsmash, reclaim, etc.); operation as a migration service; handling of security framework trusted I/O (e.g., SEV-TIO handling); trusted execution environment (TEE) device interface security protocol (TDISP) handling (e.g., secure protocol and data model (SPDM), integrity and data encryption key management); TEE device interface (TDI) management; enhancements to the security framework; handling of secure CXL memory/accelerators, scalable I/O virtualization (SIOV) and others; and can act as a device security manager for integrated devices such as DACC.

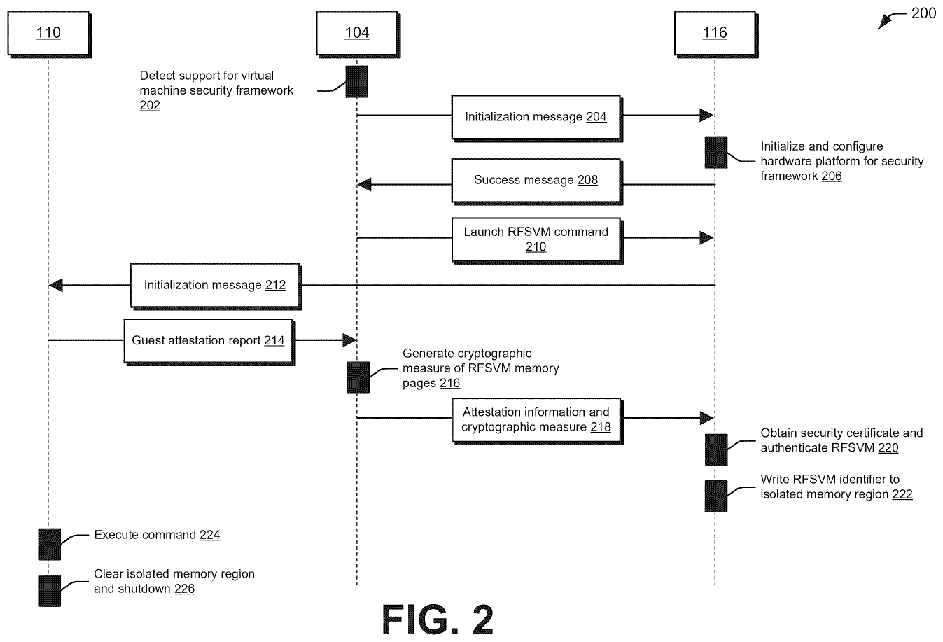

FIG. 2 is a block diagram of a non-limiting example system 200 showing the hardware platform 102 in greater detail as launching a root framework-secure virtual machine 110 in accordance with the described techniques. Specifically, FIG. 2 depicts the virtual machine monitor 104, the embedded security processor 116, and the root framework-secure virtual machine 110. The virtual machine monitor 104 is configured to detect support (e.g., by the hardware platform 102) for implementing the virtual machine security framework described herein (block 202).

In some implementations, the virtual machine monitor 104 detects that the hardware platform 102 supports the virtual machine security framework described herein in response to detecting that the hardware platform 102 supports a security protocol, such as the Peripheral Component Interconnect Trusted Execution Environment (PCI EEE) Device Interface Secure Protocol. In implementations, the virtual machine monitor 104 identifies that the hardware platform 102 supports the PCI EEE Device Interface Secure Protocol based on data stored in certain locations in memory 118 of the hardware platform 102 (e.g., capability registers of the hardware platform 102). For instance, the memory 118 includes capability registers that store information describing different capabilities supported by the hardware platform 102, such as power management, MSI (Message Signaled Interrupts), or PCIe (PCI Express), and so forth. In implementations, each capability of the hardware platform 102 is identified by a capability identifier. For example, in the context of PCI TEE Device Interface Security Protocol, the hardware platform 102 capability registers indicate whether the hardware platform 102 supports this protocol and store data enabling virtual machines to interact with the hardware platform 102 securely.

In response to detecting that the hardware platform 102 supports the virtual machine security framework described herein, the virtual machine monitor 104 transmits an initialization message 204 to the embedded security processor 116. The initialization message causes the embedded security processor 116 to initialize and configure the hardware platform 102 for the virtual machine security framework (block 206). For instance, the initialization message 204 instructs the embedded security processor 116 to enable the PCI TEE Device Interface Security Protocol on the hardware platform 102 by establishing a secure protocol (e.g., the Secure Protocol and Data Model (SPDM) protocol) connection as the interface 128 and constructing PCI Integrity and Data Encryption protocol streams. The initialization message 204 further causes the embedded security processor 116 to configure the hardware platform 102 for the virtual machine security framework, such as by using a Single Root Input/Output Virtualization (SR-IOV) device's physical function to construct virtual functions and assigning hardware platform 102 resources to the respective virtual functions of guests loaded by the virtual machine monitor 104.

After initializing and configuring the hardware platform 102 for the virtual machine security framework, the embedded security processor 116 communicates a success message 208 that informs the virtual machine monitor 104 that the hardware platform 102 is prepared for launching the root framework-secure virtual machine 110. In response to receiving the success message 208, the virtual machine monitor 104 transmits a command 210 to the embedded security processor 116 that instructs the embedded security processor 116 to launch the root framework-secure virtual machine 110. The embedded security processor 116 instantiates the root framework-secure virtual machine 110 by launching the root framework-secure virtual machine 110 and transmitting an initialization message 212 to the root framework-secure virtual machine 110.

In implementations where the virtual machine security framework involves the PCI TEE Device Interface Security Protocol, for example, as part of instantiating the root framework-secure virtual machine 110, the embedded security processor 116 binds at least one of the interface 128 or the interface 130 to the embedded security processor 116. Binding the interface 128 and/or the interface 130 to the embedded security processor 116 prepares the root framework-secure virtual machine 110 for attestation by transitioning the respective interface(s) to a locked state. In the locked state, a security posture of the respective interface(s) cannot be altered without causing the interface(s) to transition to an error state. The initialization message 212 causes the root framework-secure virtual machine 110 to generate a guest attestation report 214 and transmit the guest attestation report 214 to the virtual machine monitor 104. The guest attestation report 214 is used by the virtual machine monitor 104 to establish trust in an identity and configuration of the root framework-secure virtual machine 110.

For instance, in some implementations the guest attestation report 214 includes a certificate chain for the root framework-secure virtual machine 110 that includes at least one certificate comprising a public key and metadata identifying an owner of the public key. For instance, a certificate included in the guest attestation report 214 includes a public key associated with an authoring entity (e.g., a developer) associated of the root framework-secure virtual machine 110. In some implementations, the certificate further includes a security version of the root framework-secure virtual machine 110. As a specific example, a certificate chain in the guest attestation report 214 includes multiple certificates, where each certificate key represented in the chain signs the certificate of the next key in the chain, and so forth. The first, or “root,” certificate in the chain represents the identity of a root Certificate Authority (CA). In some implementations, the guest attestation report 214 further includes a cryptographic measure of a memory page of the root framework-secure virtual machine 110 to be loaded into memory 118. The example information described herein as being included in the guest attestation report 214 is not intended to be limiting, as the format and contents of the guest attestation report 214 can vary based on the security protocol implemented by the embedded security processor 116.

In implementations where the guest attestation report 214 does not include a cryptographic measure of at least one memory page to be loaded into memory 118, the virtual machine monitor 104 is configured to generate the cryptographic measure of at least one memory page that is private to the root framework-secure virtual machine 110 (block 216). For instance, the virtual machine monitor 104 generates a cryptographic hash of at least one memory page loaded by the root framework-secure virtual machine 110 using any suitable technique. The attestation information and the cryptographic measure 218 for the root framework-secure virtual machine 110 are then provided to the embedded security processor 116.

The embedded security processor 116 uses the attestation information provided in the guest attestation report 214 to obtain a security certificate and use the security certificate to authenticate the root framework-secure virtual machine 110 (block 220). For instance, the embedded security processor 116 uses a security version number and an authoring entity identified in the guest attestation report 214 to obtain a security certificate provided by the authoring entity of the root framework-secure virtual machine 110. The hash representing the cryptographic measurement of the root framework-secure virtual machine 110 private memory pages are compared against the security certificate. In response to the cryptographic hash measurement matching the security certificate, such a match means that the root framework-secure virtual machine 110 is secure and trustworthy (e.g., that binary code of the root framework-secure virtual machine 110 is exactly as released by the authoring entity). Alternatively, if the cryptographic hash measurement does not match the security certificate, such a discrepancy is evidence of interference (e.g., malicious tampering with binary code of the root framework-secure virtual machine 110) and indicates that the root framework-secure virtual machine 110 (e.g., that the virtual machine is regarded by the computing system as a “guest” instead of a “root-trusted guest”).

In response to authenticating the root framework-secure virtual machine 110, the root framework-secure virtual machine 110 is assigned a unique identifier (e.g., an address-space identifier (ASID)), and the embedded security processor 116 writes the unique identifier to an isolated memory region (block 222). For instance, the embedded security processor 116 writes an ASID of the root framework-secure virtual machine 110 to the isolated memory region 122. Although described herein with respect to writing a unique identifier to the isolated memory region 122, in some implementations the unique identifier is written to a different access-controlled storage location, such as to a register of a processing unit 114. Other unique identifiers include a cryptographic token, virtual machine identifier, and so forth. The unique identifier assigned to the root framework-secure virtual machine 110 is unique in that it is assignable to only a single virtual machine and is immutable (e.g., persists for as long as the virtual machine is loaded onto the computing system). The isolated memory region 122 in which the unique identifier is logged is accessible by host components of the hardware platform 102 (e.g., processing unit 114) and is inaccessible to software or guests (e.g., virtual machines loaded onto the computing system) other than the root framework-secure virtual machine 110 having the unique identifier logged in isolated memory region 122.

Logging the root framework-secure virtual machine 110 into the isolated memory region 122 thus grants the root framework-secure virtual machine 110 with special privileges under the security framework described herein, such as to execute a command 224 on behalf of one or more framework-secure virtual machines 108 (e.g., using data stored in a private memory page of the one or more framework-secure virtual machines 108). As described in further detail below, the root framework-secure virtual machine 110 is configured to continue executing commands 224 until shutdown. As part of shutting down, the root framework-secure virtual machine 110 is configured to clear its unique identifier from the isolated memory region 122, or from another access-controlled storage location such as a register of processing unit 114 (block 226), such that the virtual machine monitor 104 can launch a new root framework-secure virtual machine 110, as described in further detail with respect to FIG. 4.

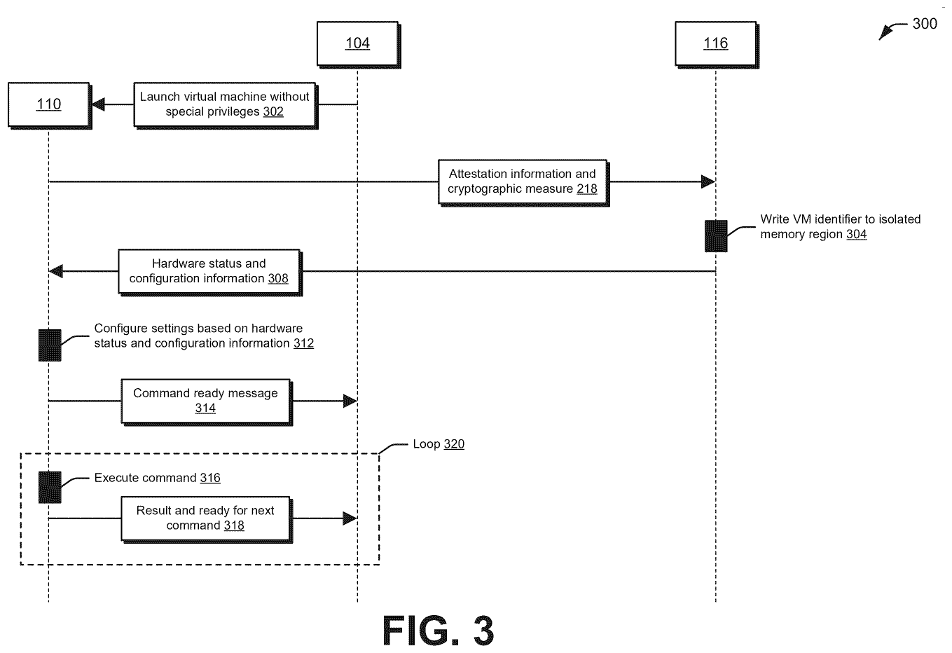

FIG. 3 is a block diagram of a non-limiting example system 300 showing the hardware platform 102 in greater detail as launching a virtual machine without special privileges and configuring the virtual machine as a root framework-secure virtual machine having special privileges. To begin, the virtual machine monitor 104 launches the root framework-secure virtual machine 110 as a virtual machine lacking special privileges (block 302). The virtual machine monitor 104, for instance, instantiates the root framework-secure virtual machine 110 as a framework-secure virtual machine 108. The virtual machine monitor 104 tasks the root framework-secure virtual machine 110 to provide attestation information and cryptographic measure 218 to the embedded security processor 116, as described above with respect to FIG. 2. After authenticating the virtual machine lacking special privileges as a root framework-secure virtual machine 110, the embedded security processor 116 writes an identifier for the virtual machine to isolated memory region 122 (block 304), which instantiates the launched virtual machine as a root framework-secure virtual machine 110.

The embedded security processor 116 then sends information 308 describing a hardware status and configuration information for the hardware platform 102 to the root framework-secure virtual machine 110. The information 308 is representative of data describing memory-mapped input/output mapping information, security attributes of memory-mapped input/output ranges, and optionally device-specific information for the hardware platform 102. In Secure Encrypted Virtualization Trusted Input/Output implementations, for instance, the root framework-secure virtual machine 110 uses the information 308 to determine whether the virtual machine monitor 104 correctly mapped the memory-mapped input/output ranges into one or more memory pages loaded by the root framework-secure virtual machine 110.

For instance, the information 308 is useable by the root framework-secure virtual machine 110 to detect that the memory-mapped input/output ranges were mapped out of order, mapped with gaps, mapped to completely different regions in memory 118, and so forth. Based on the information 308, the root framework-secure virtual machine 110 configures its internal settings (block 312). For instance, in response to determining, based on the information 308, that the memory-mapped input/output ranges are configured as expected, the root framework-secure virtual machine 110 sets the Validated bit on each page of the PCI TEE Device Interface's memory-mapped input/output ranges.

Alternatively or additionally, the root framework-secure virtual machine 110 transitions the interface 128 to an appropriate state (e.g., transitions the PCI TEE Device Interface to the PCI TEE Device Interface Security Protocol Run state). By transitioning the interface 128 to an appropriate state, the interface 128 is allowed to accept memory-mapped Input/Output requests and send direct memory access requests. In some implementations, the root framework-secure virtual machine 110 communicates a guest request to the embedded security processor 116 to program the Secure Device Table Entries of the PCI TEE Device Interface with its configuration, such as the Virtual Machine Privilege Level that the PCI TEE Device Interface has access to, input/output Memory Management Unit paging modes, and pointers to the root framework-secure virtual machine 110 page tables. After this completes, the PCI TEE Device Interface has access to the private memory pages of the one or more framework-secure virtual machines 108.

In some implementations, the root framework-secure virtual machine 110 leverages SEV_FEATURES (8B field in Virtual Machine Security Advisory) that allow SNP guests to run with additional constraints for incremental security/reduce side-channel exposure. Examples of those SEV features include, for instance, a restrict injection feature, a prevent host instruction-based sampling (IBS) feature, a SNP branch target buff (BTB) isolation feature, a VMSA register protection feature, an enhanced simultaneous multithreaded (SMT) protection feature, and so forth. In one or more implementations, the restrict injection feature is configured to restrict event/interrupt injection to a single vector, such as the virtual machine monitor 104. The prevent host instruction-based sampling feature is configured to disallow use of instruction-based sampling by the virtual machine monitor 104 to limit the information that may be gathered about the hardware platform 102.

The SNP BTB isolation feature is configured to prevent certain types of speculative execution-based side channels. When BTB isolation is enabled for SNP, the processing unit 114 ensures that no code outside of that guest context is able to influence BTB-based predictions performed by hardware by tracking the source prediction information in the BTB and flushing BTB contents when required to maintain this isolation. The VMSA register protection feature is configured to prevent certain types of side channel attacks on encrypted VMSA ciphertext by hardware obfuscating values of certain registers. In one or more implementations, the VMSA register protection feature is used for hardware platforms 102 that do not include ciphertext protection. The enhanced SMT protection feature is configured to ease restrictions by requiring a sibling thread to either idle or also run the same guest. In one or more implementations, the root framework-secure virtual machine 110's settings permit any guest with the root framework-secure virtual machine 110's address space identifier to be a legal sibling. Additionally or alternatively, the examples of the SEV features include performance counter virtualization and secure Timestamp-Counter Scaling (TSC). In one or more implementations, the performance counter virtualization feature enables full virtualization of the performance counters, allowing a guest to utilize hardware performance counters while disallowing the virtual machine monitor 104 from using performance counters to gain insight into guest behavior. These example settings and features are merely exemplary and not intended to be limiting as to a manner by which the root framework-secure virtual machine 110 configures itself based on information 308.

Upon configuring itself for the hardware platform 102 as described by the information 308, the root framework-secure virtual machine 110 sends a command ready message 314 to the virtual machine monitor 104. For instance, the root framework-secure virtual machine 110 exits from performing its normal execution via a VMGEXIT operation and signals to the virtual machine monitor 104 that it is not currently executing one or more commands (e.g., as part of its own operation or on behalf of one or more framework-secure virtual machines 108). In an example implementation, the command ready message 314 is communicated by the root framework-secure virtual machine 110 to the virtual machine monitor 104 via the Guest-Hypervisor Communication Block (GHCB).

The root framework-secure virtual machine 110 then executes a command 316 on behalf of one or more framework-secure virtual machines 108. For instance, the one or more framework-secure virtual machines 108 communicate a message via the interface 126 to the root framework-secure virtual machine 110 that requests the root framework-secure virtual machine 110 to execute command 316 using data stored in at least one memory page that is private to the one or more framework-secure virtual machines 108. Upon completing execution of the command 316, the root framework-secure virtual machine 110 outputs a result (e.g., to memory 118) and communicates an indication 318 to the virtual machine monitor 104 that is ready for a next command. This process of executing a command 316, outputting a result, and communicating indication 318 of being ready for executing a subsequent command is repeatable for any suitable number of iterations, as represented by loop 320. In some implementations, loop 320 continues until the root framework-secure virtual machine 110 is instructed to shut down.

FIG. 4 is a block diagram of a non-limiting example system 400 showing the hardware platform 102 in greater detail as launching different instances of a root framework-secure virtual machine in accordance with the described techniques. Specifically, FIG. 4 depicts the virtual machine monitor 104, the embedded security processor 116, a first instance of the root framework-secure virtual machine 110(1), and a second instance of the root framework-secure virtual machine 110(2).

To begin, the virtual machine monitor 104 launches 402 the first instance of the root framework-secure virtual machine 110(1). As described above, the first instance of the root framework-secure virtual machine 110(1) generates attestation report 404, which is useable to assign an identifier 406 to the first instance of the root framework-secure virtual machine 110(1). The identifier 406 is communicated to the embedded security processor 116, which writes the identifier of the first instance of the root framework-secure virtual machine 110(1) to isolated memory region 122 (block 408).

The virtual machine monitor 104 then launches 410 the second instance of the root framework-secure virtual machine 110(2) as a framework-secure virtual machine 108 that lacks the special privileges granted to the root framework-secure virtual machine 110. While configured as a framework-secure virtual machine 108, the second instance of the root framework-secure virtual machine 110(2) generates attestation report 412 (e.g., generates guest attestation report 214). The attestation report 412 is useable to assign an identifier 414 to the second instance of the root framework-secure virtual machine 110(2) (e.g., while still configured as only a framework-secure virtual machine 108). In some implementations, the security framework prevents the hardware platform 102 from instantiating more than one root framework-secure virtual machine 110 at a time. Thus, because identifier 406 is stored in the isolated memory region 122 (e.g., identifying that the first instance of the root framework-secure virtual machine 110(1) is active as the root framework-secure virtual machine 110), the second instance of the root framework-secure virtual machine 110(2) is prevented from operating with special privileges and remains configured as a framework-secure virtual machine 108.

The virtual machine monitor 104 transmits a shutdown command 416 to the first instance of the root framework-secure virtual machine 110(1). The shutdown command 416, for instance, causes the first instance of the root framework-secure virtual machine 110(1) to quiesce all threads of the root framework-secure virtual machine 110 and clear its identifier 406 from the isolated memory region 122 prior to shutting down (block 418). Alternatively, although not depicted in the illustrated example of FIG. 4, in some implementations the embedded security processor 116 is configured to clear the identifier 406 from the isolated memory region 122, such as in response to the virtual machine monitor 104 detecting a crash or unintended shutdown of the first instance of the root framework-secure virtual machine 110(1).

After clearing the identifier 406 from the isolated memory region 122, the second instance of the root framework-secure virtual machine 110(2) is initialized as the root framework-secure virtual machine 110 for the hardware platform 102 (block 420). As part of initialization, the second instance of the root framework-secure virtual machine 110(2) provides attestation information and cryptographic measure 218 to the embedded security processor 116, as described above. The embedded security processor 116 authenticates the second instance of the root framework-secure virtual machine 110(2) using the attestation information and cryptographic measure 218 as described above and writes the identifier 414 to isolated memory region 122 (block 422). The second instance of the root framework-secure virtual machine 110(2) then configures its settings based on the information 308. Finally, the second instance of the root framework-secure virtual machine 110(2) communicates a command ready message 314 to the virtual machine monitor 104, which indicates successful initialization and that the root framework-secure virtual machine 110 is again ready to receive a command (e.g., from the one or more framework-secure virtual machines 108).

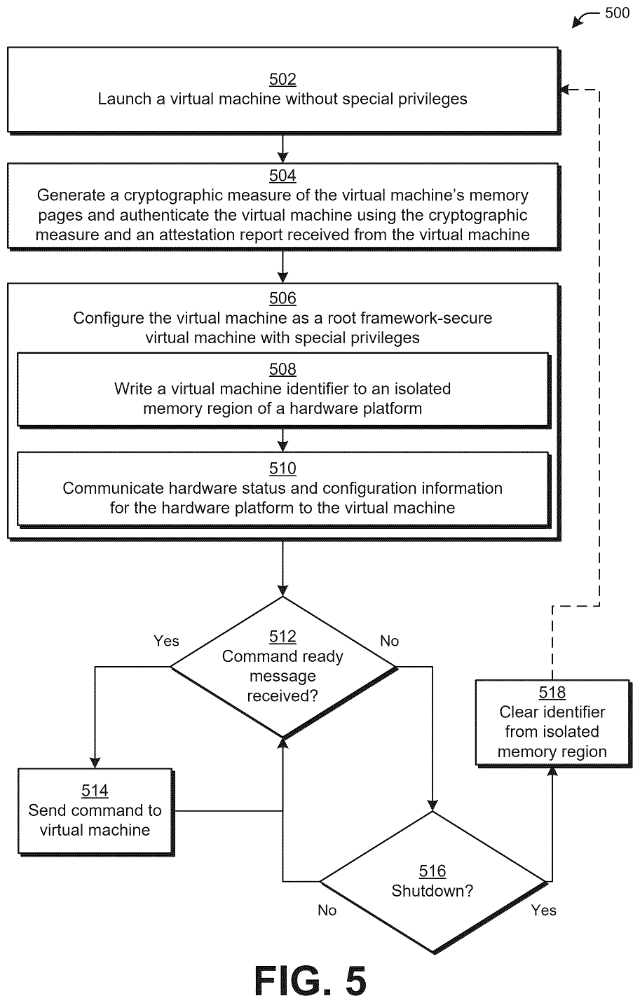

FIG. 5 is a block diagram of a non-limiting example procedure 500 describing performance of launching a root framework-secure virtual machine 110 in accordance with the techniques described herein. To being, a virtual machine is launched without special privileges (block 502). The virtual machine monitor 104, for instance, detects that the hardware platform 102 supports a virtual machine security framework, causes the embedded security processor 116 to initialize the hardware platform 102 for the security framework, and transmits the initialization message 212 to a framework-secure virtual machine launched by the virtual machine monitor 104.

A cryptographic measure of the virtual machine's memory pages is then generated and the virtual machine is authenticated using the cryptographic measure and an attestation report received from the virtual machine (block 504). The virtual machine monitor 104, for instance, receives guest attestation report 214 from the root framework-secure virtual machine 110 (e.g., still configured as only a framework-secure virtual machine 108) and generates a cryptographic measure of at least one memory page to be loaded into the memory 118. The attestation information from the guest attestation report 214 is then used by the embedded security processor 116 to obtain a security certificate and authenticate the virtual machine, as described with respect to block 220.

In response to authenticating the virtual machine, the virtual machine is configured as a root framework-secure virtual machine with special privileges (block 506). As part of part of configuring the virtual machine as a root framework-secure virtual machine, an identifier for the virtual machine is written to an isolated memory region of a hardware platform (block 508). The embedded security processor 116, for instance, writes identifier 406 to isolated memory region 122. As further part of configuring the virtual machine as a root framework-secure virtual machine, hardware status and configuration information for the hardware platform is communicated to the virtual machine (block 510). The embedded security processor 116, for instance, provides information 308 to the root framework-secure virtual machine 110, which enables the root framework-secure virtual machine 110 to configure its settings, as described with respect to block 312.

A determination is then made as to whether a command ready message is received from the root framework-secure virtual machine (block 512). The virtual machine monitor 104, for instance, waits for a command ready message 314. In response to receiving a command ready message (e.g., a “Yes” determination at block 512), a command is sent to the root framework-secure virtual machine (block 514). One or more framework-secure virtual machines 108, or the virtual machine monitor 104, for instance, send(s) a command to be executed by the root framework-secure virtual machine 110. Operation then optionally continues for at least one additional command, as indicated by the arrow returning to block 512 from block 514.

Alternatively, if a command ready message has not been received (e.g., a “No” determination at block 512), the virtual machine monitor 104 determines whether the root framework-secure virtual machine 110 has shutdown (block 516). The virtual machine monitor 104, for instance, detects whether the root framework-secure virtual machine 110 has crashed or unintentionally shut down using a watchdog or heartbeat mechanism that causes the root framework-secure virtual machine 110 to periodically send signals to the virtual machine monitor 104. In response to these heartbeat signals stopping, the virtual machine monitor 104 detects that the root framework-secure virtual machine 110 has shut down. Alternatively or additionally, the virtual machine monitor 104 implements a timeout mechanism to identify whether the root framework-secure virtual machine 110 fails to respond to a command (e.g., issued by the virtual machine monitor 104) within a threshold amount of time. Alternatively or additionally, the virtual machine monitor 104 monitors resource usage of the hardware platform 102 by the root framework-secure virtual machine 110 and detects a shutdown in response to unusual patterns that suggest the root framework-secure virtual machine 110 is no longer functioning. For instance, the virtual machine monitor 104 detects a crash of the root framework-secure virtual machine 110 in response to processing unit 114 usage dropping (e.g., to zero), unexpected halting of network traffic on interface 124 or interface 128.

In response to detecting that the root framework-secure virtual machine 110 has not shut down (e.g., a “No” determination at block 516), operation returns to block 512 and the virtual machine monitor 104 waits for command ready message 314. Alternatively, in response to detecting that the root framework-secure virtual machine 110 has shut down (e.g., a “Yes” determination at block 516), the virtual machine identifier is cleared from the isolated memory region 122 (block 518). The embedded security processor 116, for instance, clears the identifier 406 from the isolated memory region 122. Operation then optionally returns to block 502 for the virtual machine monitor 104 to launch an additional instance of the root framework-secure virtual machine 110, as indicated by the dashed arrow returning to block 502 from block 518.

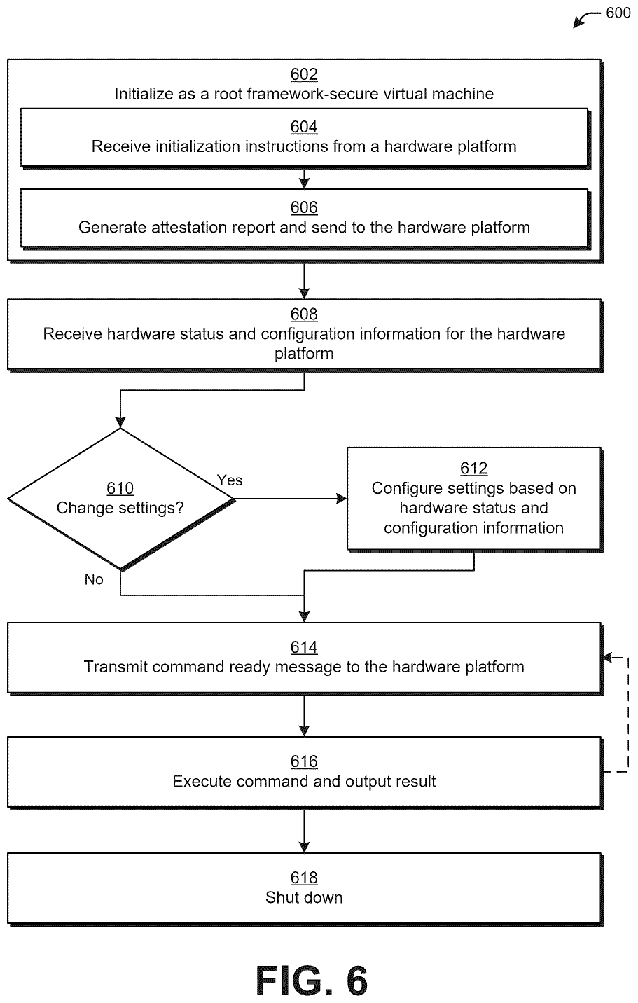

FIG. 6 is a block diagram of a non-limiting example procedure 600 describing a lifecycle of a root framework-secure virtual machine 110 in accordance with the techniques described herein. To begin, a virtual machine is initialized as a root framework-secure virtual machine (block 602). A framework-secure virtual machine 108, for instance, is initialized as a root framework-secure virtual machine 110 for the hardware platform 102. As part of initializing the virtual machine as the root framework-secure virtual machine 110, initialization instructions are received from a hardware platform (block 604) and an attestation report is sent to the hardware platform (block 606). The root framework-secure virtual machine 110, for instance, receives initialization message 212 form the embedded security processor 116 and sends guest attestation report 214 to the virtual machine monitor 104.

Hardware status and configuration information for the hardware platform is then received (block 608). The root framework-secure virtual machine 110, for instance, receives information 308 from the embedded security processor 116. Alternatively, in some implementations, the root framework-secure virtual machine 110 receives the information 308 from the virtual machine monitor 104.

A determination is then made as to whether the root framework-secure virtual machine 110 needs to change its settings based on the received information (block 610). The root framework-secure virtual machine 110, for instance, determines whether it is appropriately configured for the hardware platform 102 based on the information 308. In response to detecting that a change to at least one setting is necessary to implement the virtual machine security framework (e.g., a “Yes” determination at block 610), the root framework-secure virtual machine configures its settings based on the received information (block 612). The root framework-secure virtual machine 110, for instance, configures its settings as described above with respect to block 312.

After configuring its settings, or in response to detecting that no change in settings is necessary (e.g., a “No” determination at block 610), a command ready message is transmitted to the hardware platform (block 614). The root framework-secure virtual machine 110, for instance, transmits command ready message 314 to the virtual machine monitor 104. At least one command is executed and a result is output (block 616). The root framework-secure virtual machine 110, for instance, executes command 316 and outputs a result of executing command 316 along with an indication 318 that the root framework-secure virtual machine 110 is ready to execute another command. The root framework-secure virtual machine 110 is configured to execute any number of commands, as indicated by the dashed arrow returning to block 614 from block 616.

After executing one or more commands, the root framework-secure virtual machine shuts down (block 618). The root framework-secure virtual machine 110, for instance, receives shutdown command 416 from the virtual machine monitor 104. In response to receiving the shutdown command 416, the root framework-secure virtual machine 110 ensures that all of its threads have completed execution and clears its unique identifier from the isolated memory region 122. After clearing its unique identifier from the isolated memory region 122, the root framework-secure virtual machine 110 shuts down, as described with respect to block 418 (e.g., enabling the virtual machine monitor 104 to launch another instance of the root framework-secure virtual machine 110).

Various implementations are possible based on the disclosure herein, and the described techniques are not so limited to the specific examples described above. Although features and elements are described above in particular combinations, each feature or element is usable alone without the other features and elements or in various combinations with or without other features and elements.

The various functional units illustrated in the figures and/or described herein (including, where appropriate, the hardware platform 102 having the processing units 114, the embedded security processor 116, the memories 118, and the memory controller 120) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a hardware platform comprising physical computer hardware, the physical computer hardware including one or more processing units and one or more memories;
a virtual machine monitor configured to virtualize the physical computer hardware of the hardware platform to instantiate a plurality of framework-secure virtual machines; and
a root framework-secure virtual machine instantiated by the virtual machine monitor, the root framework-secure virtual machine configured to control access to the hardware platform by the plurality of framework-secure virtual machines instantiated by the virtual machine monitor.

2. The system of claim 1, wherein the root framework-secure virtual machine is instantiated with permissions that are not granted to the plurality of framework-secure virtual machines.

3. The system of claim 1, wherein the root framework-secure virtual machine is configured to implement a security framework for the plurality of framework-secure virtual machines.

4. The system of claim 1, wherein the virtual machine monitor is configured to instantiate the root framework-secure virtual machine by transmitting an initialization message that causes the root framework-secure virtual machine to generate an attestation report that is useable by the hardware platform to authenticate the root framework-secure virtual machine.

5. The system of claim 4, wherein the attestation report comprises information describing at least one of an authoring entity associated with the root framework-secure virtual machine, a security version of the root framework-secure virtual machine, or a memory page to be loaded by the hardware platform for the root framework-secure virtual machine.

6. The system of claim 5, wherein the virtual machine monitor is configured to authenticate the root framework-secure virtual machine by generating a cryptographic measurement of the memory page to be loaded by the hardware platform for the root framework-secure virtual machine.

7. The system of claim 6, wherein the virtual machine monitor is configured to authenticate the root framework-secure virtual machine by obtaining a security certificate from the authoring entity associated with the root framework-secure virtual machine and compare the cryptographic measurement against the security certificate.

8. The system of claim 1, wherein the one or more memories include an isolated memory region that is accessible to the root framework-secure virtual machine and inaccessible to the plurality of framework-secure virtual machines.

9. The system of claim 8, wherein the virtual machine monitor is configured to instantiate the root framework-secure virtual machine by writing a unique identifier for the root framework-secure virtual machine to the isolated memory region.

10. The system of claim 9, wherein the root framework-secure virtual machine is configured to clear the unique identifier from the isolated memory region prior to shutting down.

11. The system of claim 9, wherein the virtual machine monitor is configured to clear the unique identifier from the isolated memory region in response to detecting that the unique identifier persists in the isolated memory region after shutdown of the root framework-secure virtual machine.

12. The system of claim 11, wherein the virtual machine monitor is configured to instantiate an additional root framework-secure virtual machine in response to detecting that the unique identifier persists in the isolated memory region after shutdown of the root framework-secure virtual machine.

13. The system of claim 1, wherein the virtual machine monitor is configured to instantiate the root framework-secure virtual machine by providing data describing a status and configuration information for the hardware platform to the root framework-secure virtual machine.

14. A method comprising:
launching, by a computing device, a virtual machine;
authenticating, by the computing device, the virtual machine by generating a cryptographic measure of at least one memory page loaded by the virtual machine;
configuring, by the computing device, the virtual machine as a root framework-secure virtual machine that is configured to control access to the computing device by at least one other virtual machine; and
executing, using hardware resources of the computing device, at least one command issued by the root framework-secure virtual machine on behalf of the at least one other virtual machine.

15. The method of claim 14, wherein authenticating the virtual machine comprises obtaining a security certificate from an authoring entity associated with the virtual machine and comparing the cryptographic measure of the at least one memory page against the security certificate.

16. The method of claim 14, wherein configuring the virtual machine as the root framework-secure virtual machine comprises writing a unique identifier for the root framework-secure virtual machine to an isolated region in memory of the computing device that is accessible to the root framework-secure virtual machine and inaccessible to the at least one other virtual machine.

17. The method of claim 16, further comprising clearing the unique identifier for the root framework-secure virtual machine from the isolated region in the memory of the computing device in response to detecting an unintended shutdown of the root framework-secure virtual machine.

18. The method of claim 16, further comprising transmitting a shutdown command to the root framework-secure virtual machine that causes the root framework-secure virtual machine to clear the unique identifier for the root framework-secure virtual machine from the isolated region in the memory of the computing device prior to shutting down.

19. The method of claim 14, wherein launching the virtual machine comprises providing data describing a status and configuration information for the computing device to the virtual machine.

20. A method comprising:
receiving, by a virtual machine, an initialization message from a virtual machine monitor of a hardware platform;
sending, by the virtual machine and to the virtual machine monitor, an attestation report in response to receiving the initialization message, the attestation report comprising information describing at least one of an authoring entity of the virtual machine, a security version of the virtual machine, or a memory page to be loaded into memory of the hardware platform for the virtual machine;
receiving, by the virtual machine and from the virtual machine monitor, data that permits the virtual machine to control access, to the hardware platform, by at least one other virtual machine instantiated by the virtual machine monitor; and
executing, by the virtual machine and using resources of the hardware platform, at least one command on behalf of the at least one other virtual machine.
